(19) United States
(12) Patent Application Publication
(10) Pub. No.: US 2006/0108190 A1
(43) Pub. Date: May 25, 2006

(54) Vibration damper with adjustable damping force

(75) Inventor: Andreas Forster, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/271,614

(22) Filed: Nov. 10, 2005

(30) Foreign Application Priority Data
Nov. 11, 2004 (DE) 10 2004 054 474.3

(51) Int. Cl. F16F 9/00

(52) U.S. Cl. 188/318

(57) ABSTRACT

A vibration damper with adjustable damping force includes a cylinder containing a damping medium, a piston rod which is axially movable in the cylinder, and a piston arranged for axial movement in the damping medium, the piston being connected to the piston rod and dividing the cylinder into a working space around the piston rod and a working space opposite the piston rod. At least one adjustable damping valve is connected to a respective at least one of the working spaces by a fluid connection through which damping medium can flow with a flow velocity, and an auxiliary damping valve is connected in series with each adjustable damping valve with respect to the flow, the auxiliary damping valve moving in a closing direction as a function of the flow velocity.

### BACKGROUND OF THE INVENTION

1. Field of the Invention

The invention pertains to a vibration damper with adjustable damping force, including a cylinder containing a damping medium, a piston rod which is axially movable in the cylinder, a piston arranged for axial movement in said damping medium, the piston being connected to the piston rod and dividing the cylinder into a working space around the piston rod and a working space opposite the piston rod, and an adjustable damping valve connected to one of the working spaces by a fluid connection through which damping medium can flow with a flow velocity.

2. Description of the Related Art

Adjustable vibration dampers such as those known from U.S. Pat. No. 5,937,975 are intended to solve the conflict between a somewhat harder damping force setting, which tends to offer more driving safety, and a softer damping force setting, which provides greater comfort. The variables which represent the movement of the vehicle such as driving speed and transverse and/or vertical acceleration are detected by sensors, the signals of which are converted by a control unit into actuating signals and transmitted to the adjustable vibration dampers.

The overall system should react as quickly as possible to obstacles in the road or other influences. For example, road detectors such as cameras can be used. At first glance, it is true that such measures increase the lead time between, for example, the detection of a pothole and the rebound of the wheel in question. Image evaluation, however, is a highly computer-intensive process, and it is not always reliable. Another possibility is to equip the adjustable vibration dampers with extremely efficient sensors and actuators. This approach, however, will inevitably exceed certain cost limits and make it impossible to market the product.

At present, a conscious choice is made to adjust the damping force in a way which falls short of maximum comfort. The reason for this is that, if comfort were the only criterion, the overall system of the adjustable vibration damper would react too slowly to provide adequate driving safety in the event that the vehicle were to travel over a major obstacle. It would also be possible to use tension or compression stops, but these are always dependent on distance and for this reason lead to a loss of comfort when, for example, the elastic deflections are slow during straight-ahead travel of the vehicle.

### SUMMARY OF THE INVENTION

The task of the present invention is to realize an adjustable vibration damper which allows the damping forces to be set to a more comfortable value.

This task is accomplished according to the invention by connecting an auxiliary damping valve, which moves in the closing direction as a function of the flow velocity of the damping medium, in series with the adjustable damping valve with respect to the flow of damping medium.

The great advantage is that the delay time of the adjustable damping valve, which can be overcome only with considerable technical effort, can be compensated by a simple additional damping valve. That is, this additional damping valve brakes the peak velocities which the piston rod reaches when, for example, the vehicle travels over an obstacle. Especially when the piston rod reaches its point of maximum inward travel at very high velocity, damage can occur to the body of the vehicle, which in turn can be prevented only by reinforcing the body. When such a damping force-increasing auxiliary damping valve is present, it is possible to slow down the system, that is, to increase the time it takes for the actuators to be reset after the signal has been picked up by the sensors. This has the effect of lowering costs and can make it possible to lower the minimal damping force of the vibration damper even more, which provides an advantageous increase in driving comfort. When an obstacle is actually encountered on the road, however, the additional damping valve provides the necessary safety.

In another advantageous embodiment of the invention, the damping force-increasing damping valve is installed upstream of the adjustable damping valve. The damping force-increasing damping valve acts in practice as a series resistor, which goes into effect when needed to protect the adjustable damping valve.

Depending on how the damping force-increasing damping valve is dimensioned and designed, it is possible for the vibration damper, especially the working space being compressed at the time in question, to be damaged when the piston rod travels at extremely high velocity. For this reason, a pressure-limiting valve is connected in parallel with the damping force-increasing damping valve. The pressure-limiting valve opens whenever the pressure reaches a certain limit and thus creates a bypass around the damping force-increasing damping valve.

For example, the pressure-limiting valve can be installed in a flow connection between one of the working spaces and a compensating space, which is used to compensate for the volume displaced by the piston rod. Alternatively, the pressure-limiting valve can be installed in a flow connection between the two working spaces.

According to an advantageous embodiment, the damping force-increasing auxiliary damping valve is installed at any desired point between the inlet and the outlet of the fluid connection leading to the adjustable damping valve.

In another advantageous embodiment, the damping force-increasing auxiliary damping valve is formed by a ram pressure-actuated closing body.

The closing body can be designed as a closing ring, for example, which controls the cross section of the inlet.

An especially simple variant of a damping force-increasing damping valve is achieved in that the outside surface of the closing ring and the inside wall of the cylinder form a throttle, which produces a pressure gradient with respect to an inside surface of the closing ring. The ram pressure present in one of the working spaces ensures that the closing ring rests elastically against the inside wall of the cylinder and at least partially closes the inlet in the direction toward the adjustable damping valve.

Alternatively or in addition, the piston can have a connecting channel between the two working spaces, which channel can be at least partially closed by the closing body.

In a simpler variant of an adjustable vibration damper, a single adjustable damping valve is provided for both directions of piston rod movement, and damping medium is displaced toward the adjustable damping valve via the connecting channel in the piston.

Alternatively, the invention can also be used when an independently adjustable damping valve is present for each of the two directions of piston rod movement.

In an alternative variant, a throttle is connected in parallel with the adjustable damping valve, where a damping valve which moves in the closing direction as a function of the flow velocity of the damping medium is connected in series with this throttle. This variant is of interest especially when, for example, in the case of a vibration damper designed as a MacPherson strut unit, a piston rod with a comparatively large diameter is used. The damping medium which is displaced is divided into a first partial volume stream, which flows through the throttle, and a second partial volume stream, which flows through the adjustable damping valve. So that a linear or degressive damping force curve can be obtained, the throttle is designed as a damping valve, e.g., with at least one valve disk, which cooperates with a valve body.

The throttle can be located in the piston, or it can be designed as a bottom valve in the working space on the side opposite the piston rod.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a diagram of an inventive vibration damper with an adjustable damping valve for each direction of piston rod movement;

FIG. 2 shows an exemplary embodiment of the damper in FIG. 1;

FIG. 3 is a diagram of an inventive vibration damper with a single adjustable damping valve for both directions of piston rod movement;

FIG. 4 shows an exemplary embodiment of the damper in FIG. 3;

FIG. 5 is a detail of the piston in FIG. 4; and

FIG. 6 shows a bottom valve with a damping valve which can be moved in the closing direction as a function of the flow velocity.

### DETAILED DESCRIPTION OF THE PRESENTLY PREFERRED EMBODIMENTS

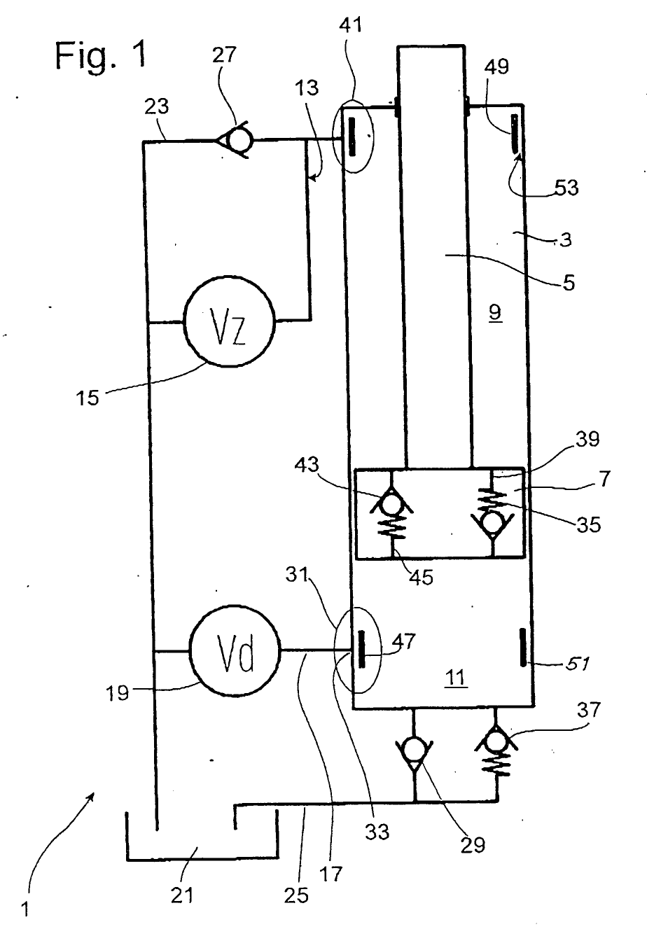

FIG. 1 shows a diagram of a vibration damper 1, which comprises a damping medium-filled cylinder 3, in which a piston rod 5, together with a piston 7, is guided with freedom of axial movement. The piston 7 divides the cylinder 3 into a working space 9 on the piston rod side and a working space 11 on the side opposite the piston rod. In principle, the piston can be a simple displacement body without through-channels. The piston rod-side working space 9 is connected to an adjustable damping valve 15 by a fluid connection 13. The working space 11 on the side opposite the piston rod also has a fluid connection 17, which leads to an independently adjustable damping valve 19. The damping medium displaced from the working spaces in question and thus to the adjustable damping valves then flows to a compensating space 21. The piston rod-side working space 9 and the space 11 on the opposite side are connected to the compensating space 21 by return lines 23, 25 in combination with nonreturn valves 27, 29, which open in the flow direction leading toward the respective working spaces.

An auxiliary damping valve 31, 41, which acts during the inward travel of the piston rod and which moves in the closing direction as a function of the flow velocity of the damping medium, is connected in series at least with the adjustable damping valve 19 with respect to the direction of flow. The auxiliary damping valve 31 is installed upstream of the adjustable damping valve 19 at any desired point between the inlet 33 and the outlet of the fluid connection 17 leading to the adjustable damping valve 19. A pressure-limiting valve is connected parallel to the damping force-increasing damping valve 31. For example, a pressure-limiting valve 35 can be located in the flow connection 39 between the two working spaces 9, 11, possibly in the piston 7, as shown. Alternatively, a pressure-limiting valve 37 can be installed between the working space 11 on the side opposite the piston rod and the compensating space 21.

The piston rod-side working space 9 can also be equipped with a damping force-increasing auxiliary damping valve 41, which is connected in series with the adjustable damping valve 15. In this case, a pressure-limiting valve 43 can be installed, for example, in a flow connection 45 in the piston.

Each damping force-increasing damping valve 31, 41 is formed by a closing body in the form of a closing ring 47, 49, the outside surface of which cooperates with the inside wall of the cylinder to form a throttle 51, 53.

When the vibration damper is operating under normal conditions, the piston rod 5 travels together with the piston 7 into the cylinder 3 and compresses the working space 11 on the side opposite the piston rod. The pressure-limiting valve 35 in the piston 7 or the alternative pressure-limiting valve 37 at the bottom of the working space 11 is closed, as is the nonreturn valve 29. As a function of the desired damping force, the damping medium, which is under pressure in the working spaces 11, can escape via the inlet 33 of the fluid connection 17 and flow to the adjustable damping valve 19 and then to the compensating space 21 and/or flow via the opened nonreturn valve 27 into the ring-shaped working space 9 on the piston rod side, so that no negative pressure can build up there.

When the piston rod travels inward at extreme velocity, the throttle 51 has the effect of creating a pressure gradient between the inlet 33 and the inside surface of the closing ring 47, 49. The ram pressure acting on the inside surface of the closing ring 47 can thus press the closing ring onto the inlet 33 and seal it off as completely as possible. The damping force of the vibration damper is now determined by the remaining cross section present in the area of the inlet. The adjustable damping valve 19 has no effect on the damping force, which means its current setting is completely irrelevant. When the pressure in the working space 11 exceeds a certain level, the pressure-limiting valve 35 or 37 makes it possible for additional damping medium to escape and thus protects the vibration damper from damage.

The same applies in principle to the outward travel of the piston rod 5. Below a defined piston rod velocity, the damping force-increasing auxiliary damping valve 41 is completely open. When this piston rod velocity is exceeded, however, the closing body 49 closes the fluid connection 13 leading to the adjustable damping valve 15. Under certain conditions, the pressure-limiting valve 45 in the flow connection 43 can also open.

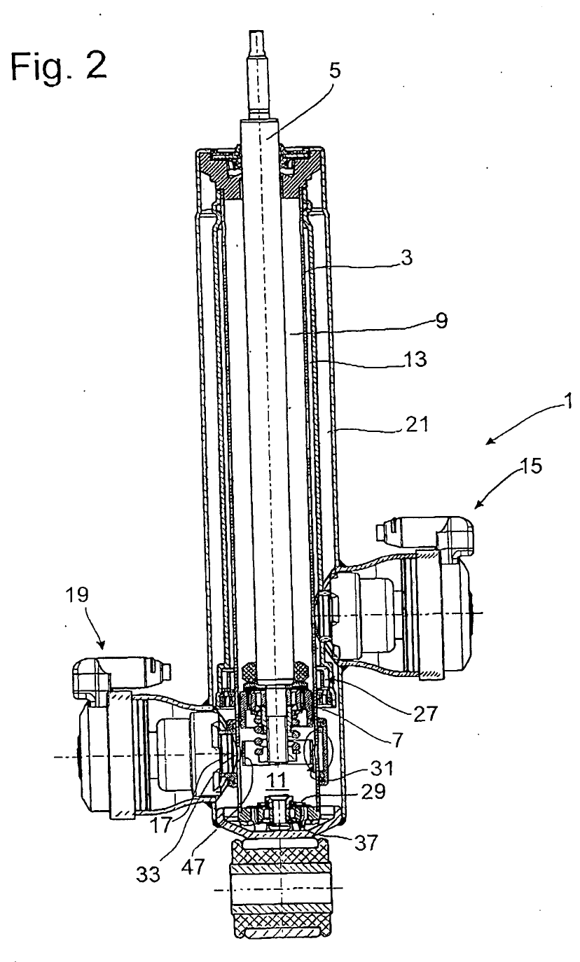

FIG. 2 shows a concrete design realization of the vibration damper according to FIG. 1. The design has been modified by the omission of the damping force-increasing damping valve 41, because the velocity which can be reached by the piston rod is determined by the force of the vehicle suspension springs and is therefore in most cases considerably less than the velocity which the piston rod can reach in the inward direction when the wheel travels over an obstacle.

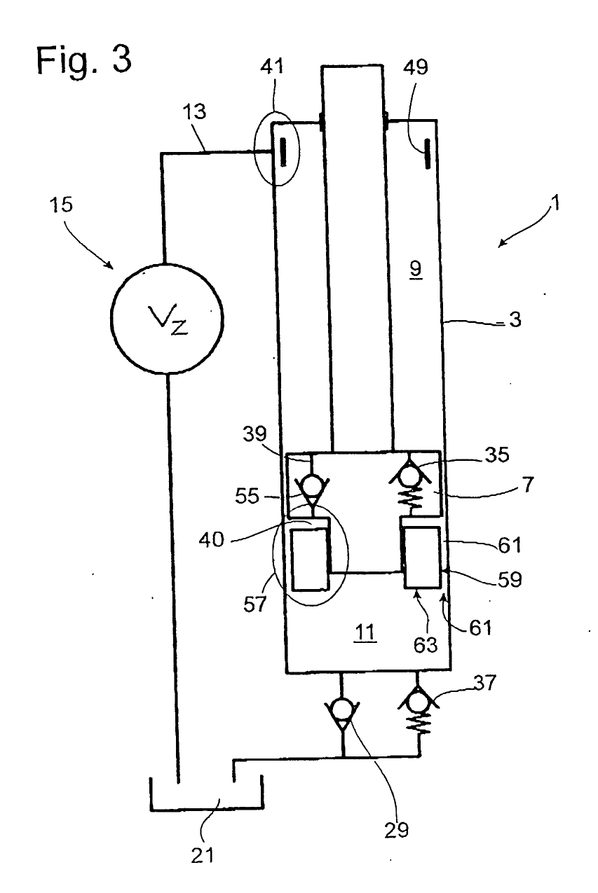

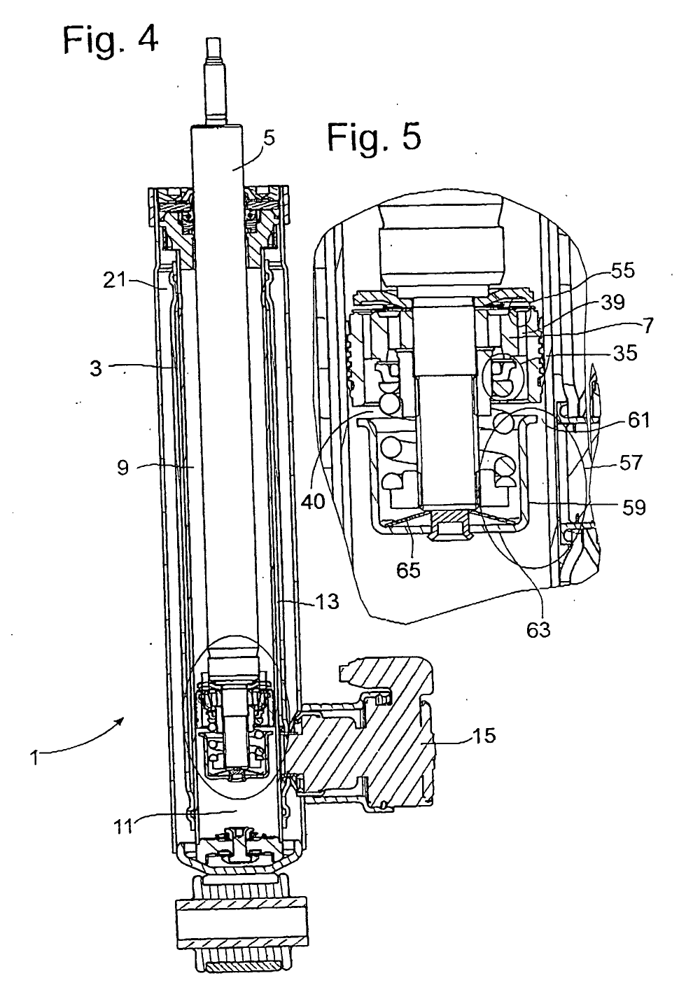

FIGS. 3 and 4 show a variant of an adjustable vibration damper 1, which has a single adjustable damping valve 15 for both directions of piston rod movement. The piston rod-side working space 9 is connected to the adjustable damping valve 15 by the fluid connection 13. The flow connection 39 together with a nonreturn valve 55 is provided in the piston 7; this flow connection connects the two working spaces 9, 11 during the inward travel of the piston rod and separates them during the outward travel of the piston rod. During inward travel, the damping medium present in the working space 11 is compressed, and the nonreturn valve 29 leading to the compensating space remains closed. The pressure-limiting valve 37 between the working space 11 on the side opposite the piston rod and the compensating space 21 is also closed. The entire volume displaced from the working space 11 on the side opposite the piston rod flows into the piston rod-side working space 9 through a connecting channel 40, i.e., the open flow connection 39. The volume of damping medium displaced by the inward-traveling piston rod then flows from the working space 9 to the adjustable damping valve 15. When the piston rod travels outward, the nonreturn valve 55 is closed, so that the entire volume of the ring-shaped space flows out from the piston rod-side working space to the damping valve. The nonreturn valve 29 prevents negative pressure from building up in the working space 11 on the side opposite the piston rod. Thus the flow through the fluid connection 13 always flows in only one direction, so that a single damping valve 15 can be used to adjust the damping force for both directions of piston rod movement.

Whenever the inward travel velocity of the piston rod exceeds a defined value, a damping valve 57 goes into action and increases the damping force. The damping valve 57 has a closing body in the form of a control slide 59, which cooperates with the inside wall of the cylinder 3 or with the piston to form a throttle 61. The control slide has a pressure-actuated ram pressure surface 63 oriented toward the working space 11 on the side opposite the piston rod; when the pressure on this surface is high enough, the control slide is pushed axially toward the piston, as a result of which the flow connection 39 is at least partially closed. When the piston rod is traveling inward, the damping valve 57, which is upstream of the adjustable damping valve 15, determines the damping force. Under certain conditions, the pressure-limiting valve 37 can then open as well and allow damping medium to escape to the compensating space 21.

If the outward travel direction is also to be provided with a damping valve 41 to increase the damping force as a function of pressure as already described in conjunction with FIG. 1, it can be advisable to provide a pressure-limiting valve 35, for example, in the piston as well.

FIG. 4, which shows a vibration damper according to the diagram of FIG. 3 in longitudinal cross section, and FIG. 5, which shows a detailed view of the piston, are intended to illustrate how simple yet highly effective the design of the damping force-increasing damping valve 57 is. A restoring spring 65 ensures that the control slide 59 of the damping force-increasing damping valve 57 moves back into its open position and therefore the damping force is not adjusted as a function of the length of the stroke. For the sake of clarity, the damping valve 41 is not shown in FIG. 4.

The nonreturn valve 55 in FIG. 5 can also be designed as a throttle, which cooperates with a valve disk to form a conventional damping valve. The damping valve 57 in the piston 7 has the effect of increasing the damping force as a function of velocity in the closing direction and is connected functionally in series with this damping valve. The two valves 55, 57 are in turn connected in parallel with the adjustable damping valve.

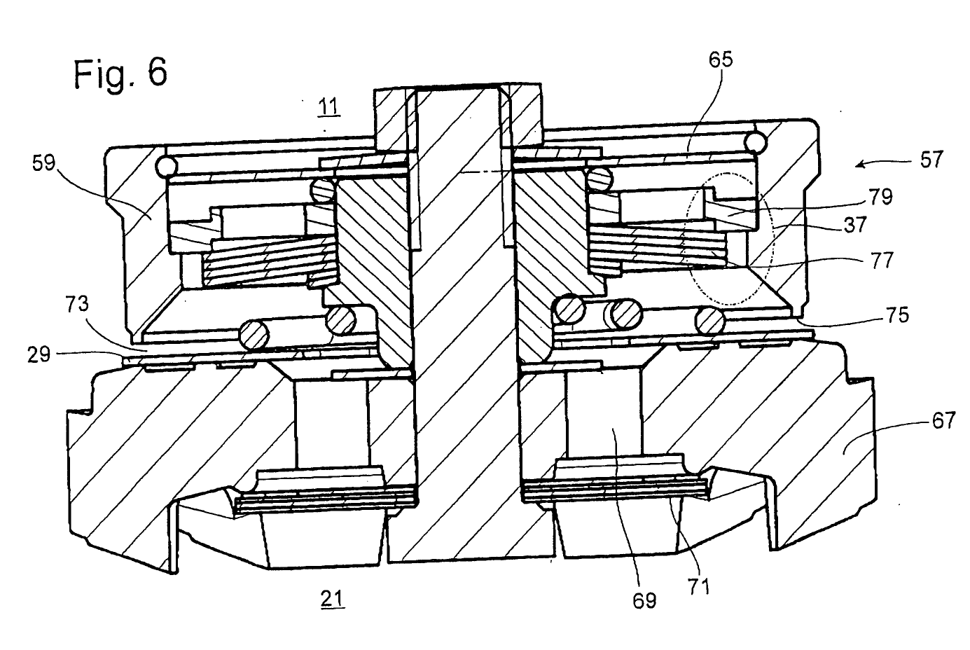

FIG. 6 shows a bottom valve 57 designed in accordance with the functional principle of the damping valve 57 according to FIG. 5. This bottom valve can be used in FIG. 2 or in FIG. 4, for example, to produce two partial streams as the piston rod 5 travels inward, as also described in conjunction with FIG. 5.

A bottom valve body 67 has a number of throttles 69, which cooperate with at least one valve disk 71 to form a damping valve. This damping valve opens from the working space 11 on the side opposite the piston rod toward the compensating space 21. Above the bottom valve, a control slide 59 is held by a restoring spring 65 in a position which allows damping medium to reach a throttle 73. As soon as a sufficient pressure gradient is present as a result of the flow velocity at the throttle 73, the face 75 of the control slide can come to rest against the top surface of the nonreturn valve 29 and block the further partial volume stream proceeding toward the compensating space 21. After this state has been reached, all of the volume displaced by the piston rod 5 flows to the adjustable damping valve 15. When the pressure in the working space on the side opposite the piston rod exceeds a certain limit, the pressure-limiting valve 37, consisting of at least one elastic valve disk 77, can be lifted from the valve seat ring 79 and thus opened, this valve being connected in parallel with the throttle 73.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vibration damper with adjustable damping force, the damper comprising:
a cylinder containing a damping medium;
a piston rod which is axially movable in said cylinder;
a piston arranged for axial movement in said damping medium, said piston being connected to said piston rod and dividing said cylinder into a working space around the piston rod and a working space opposite the piston rod;
an adjustable damping valve connected to one of said working spaces by a fluid connection through which damping medium can flow with a flow velocity; and
an auxiliary damping valve in series with the adjustable damping valve with respect to the flow, said auxiliary damping valve moving in a closing direction as a function of the flow velocity.

2. The vibration damper of claim 1 wherein the auxiliary damping valve is upstream of the adjustable damping valve.

3. The vibration damper of claim 1 further comprising a pressure limiting valve connected to said one of said working spaces in parallel with said auxiliary damping valve.

4. The vibration damper of claim 3 further comprising:
a compensating space connected to said one of said working spaces by a flow connection; and
a pressure-limiting valve installed in the flow connection to compensate for damping medium displaced by the piston rod.

5. The vibration damper of claim 3 further comprising a flow connection connecting the working spaces, said pressure limiting valve being installed in said flow connection.

6. The vibration damper of claim wherein the fluid connection joins the cylinder at an inlet, said auxiliary damping valve being located at the inlet.

7. The vibration damper of claim 1 wherein the auxiliary damping valve comprises a closing body actuated by ram pressure.

8. The vibration damper of claim 7 wherein the closing body is a closing ring which expands in response to ram pressure in order to close the fluid connection.

9. The vibration damper of claim 7 wherein the cylinder has an inside surface and the closing ring has an outside surface which faces the inside surface to form a throttle.

10. The vibration damper of claim 1 further comprising:
a connecting channel in the piston, said connecting channel connecting the working spaces; and
a closing body in one of the working spaces, said closing body at least partially closing the connecting channel.

11. The vibration damper of claim 9 wherein said adjustable damping valve controls damping for both directions of piston rod movement, said damping medium flowing toward the adjustable damping valve via the connecting channel.

12. The vibration damper of claim 1 wherein the adjustable damping valve is connected to the working space around the piston rod, the vibration damper further comprising:
a second adjustable damping valve connected to the working space opposite the piston rod by a second fluid connection through which damping medium can flow with a flow velocity; and
a second auxiliary damping valve in series with the second adjustable damping valve with respect to the flow, said second auxiliary damping valve moving in a closing direction as a function of the flow velocity.

13. A vibration damper with adjustable damping force, the damper comprising:
a cylinder containing a damping medium;
a piston rod which is axially movable in said cylinder;
a piston arranged for axial movement in said damping medium, said piston being connected to said piston rod and dividing said cylinder into a working space around the piston rod and a working space opposite the piston rod;
an adjustable damping valve connected to one of said working spaces by a fluid connection through which damping medium can flow with a flow velocity;
a throttle in parallel with the adjustable damping valve; and
an auxiliary damping valve in series with the throttle with respect to the flow, said auxiliary damping valve moving in a closing direction as a function of the flow velocity.

14. The vibration damper of claim 13 wherein the throttle is formed by a damping valve.

15. The vibration damper of claim 13 wherein the throttle is formed in the piston.

16. The vibration damper of claim 13 wherein the throttle is formed by a bottom valve in the working space opposite the piston rod.
